(19) United States
(12) Patent Application Publication
(10) Pub. No.: US 2014/0161200 A1
(43) Pub. Date: Jun. 12, 2014

(54) System to Determine Associated Electronic Devices

(71) Applicant: Maxim Integrated Products, Inc., (US)

(72) Inventors: Hal Kurkowski, Dallas, TX (US); Carlton Michael Haight, Dallas, TX (US); John Wettroth, Cary, NC (US)

(73) Assignee: Maxim Integrated Products, Inc., San Jose, CA (US)

(21) Appl. No.: 13/711,896

(22) Filed: Dec. 12, 2012

(51) Int. Cl. G08B 1/08

(52) U.S. Cl. CPC G08B 1/08
USPC 375/257; 375/259

(57) ABSTRACT

Various embodiments of the invention allow for electronic labeling and identification of electronic equipment. Contact-based and contactless systems and methods to electronically associate hardware are described.

### BACKGROUND

A. Technical Field

The present invention relates to electronic labeling of electronic devices. More particularly, the present invention relates to systems and methods to identify compatible electronic devices.

B. Background of the Invention

Power systems and accessories often have no standardized output connectors. Various AC/DC power adapters, for example, have output connectors with different dimensions and configurations, including different output current and voltage ratings or polarities. The non-uniformity across a variety of types of power systems from different manufacturers typically makes power adapters mechanically and electrically incompatible with more than one product. Although most power adapters contain engraved symbols or labels with markings, the provided information oftentimes appears cryptic to the common user, in part, because the information is insufficient to even determine the supplier of the power adapter. Even when a particular adapter contains information such as part numbers, these usually identify only the supplier without identifying the equipment that the adapter belonged to at time of purchase. Therefore, once a consumer separates an adapter from an associated product, be it a power drill, a shop light, or a game console, it becomes difficult to determine to which product a certain disassociated adapter originally belonged.

The lack of standardization leads to compatibility issues not only between different devices from different suppliers or manufacturers, but also between different devices made by a single supplier. For example, if a newer model device has voltage, current, or power requirements different from an older model by the same supplier, there is a substantial likelihood that the older model power adapter does not match one or more requirements of the newer model adapter. In addition, connecting an AC adapter to an electrical device that has a matching output connector dimensions but opposite polarity or different voltage, current, or power requirements can potentially damage the product or, in extreme cases, pose a safety risk to the user.

The lack of reliable standards at the very least creates uncertainty and confusion to the average consumer, who cannot decipher labels and imprints to easily decide which power adapter to use with which device. As a result, over time, consumers gather drawers full of orphaned power adapters that eventually end up as landfill material. One exemplary consumer survey showed widespread dissatisfaction among consumers with the cost, inconvenience, and wastefulness of the profusion of AC/DC power adapters used by electronic devices.

What is needed are tools to overcome the above-described limitations.

### SUMMARY OF THE INVENTION

Various embodiments of the invention provide for low-cost means to implement an electronic label that contains identifying information for a piece of hardware, such as an AC/DC power adapter.

In particular, certain embodiments of the invention provide for an electronic label that carries information regarding the piece of hardware and an associated product. The identifying information allows a consumer to easily determine mismatched or misplaced equipment to correctly re-associate power devices and powered devices, and, thus, to prevent a premature disposal of otherwise functional electronic products.

Both contact-based and contactless approaches to electronically associate an electronic product with a matching electronic product are described.

Certain features and advantages of the present invention have been generally described in this summary section; however, additional features, advantages, and embodiments are presented herein or will be apparent to one of ordinary skill in the art in view of the drawings, specification, and claims hereof. Accordingly, it should be understood that the scope of the invention shall not be limited by the particular embodiments disclosed in this summary section.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1A is a block diagram illustrating a contact-based identification system to associate devices according to various embodiments.

FIG. 1B is a block diagram illustrating another contact-based identification system to associate devices according to various embodiments.

FIG. 1C illustrates an implementation of an output connector for use in an identification system to associate devices according to various embodiments.

FIG. 1D illustrates an alternative implementation of an output connector for use in an identification system to associate devices according to various embodiments.

FIG. 2A is a block diagram illustrating a contactless identification system according to various embodiments.

FIG. 2B is a block diagram illustrating an alternate contactless identification system to associate devices according to various embodiments.

FIG. 3 is a block diagram illustrating an identifier tag according to various embodiments.

FIG. 4 is a block diagram illustrating a contactless ID reader according to various embodiments.

FIG. 5 is a flowchart of an illustrative contact-based process for identifying associate devices in accordance with various embodiments of the invention.

FIG. 6 is a flowchart of an illustrative contactless process for identifying associate devices in accordance with various embodiments of the invention.

### DETAILED DESCRIPTION OF THE PREFERRED EMBODIMENTS

In the following description, for the purpose of explanation, specific details are set forth in order to provide an understanding of the invention. It will be apparent, however, to one skilled in the art that the invention can be practiced without these details. One skilled in the art will recognize that embodiments of the present invention, described below, may be performed in a variety of ways and using a variety of means. Those skilled in the art will also recognize additional modifications, applications, and embodiments are within the scope thereof, as are additional fields in which the invention may provide utility. Accordingly, the embodiments described below are illustrative of specific embodiments of the invention and are meant to avoid obscuring the invention.

Reference in the specification to “one embodiment” or “an embodiment” means that a particular feature, structure, characteristic, or function described in connection with the embodiment is included in at least one embodiment of the invention. The appearance of the phrase “in one embodiment,” “in an embodiment,” or the like in various places in the specification are not necessarily all referring to the same embodiment.

Furthermore, connections between components or between method steps in the figures are not restricted to connections that are affected directly. Instead, connections illustrated in the figures between components or method steps may be modified or otherwise changed through the addition thereto of intermediary components or method steps, without departing from the teachings of the present invention.

In this document the terms “contactless transponder reader” and “contactless reader” and “transponder reader” are used interchangeably. The term “computer” is meant to include mobile and non-mobile computing devices recognized by one skilled in the art.

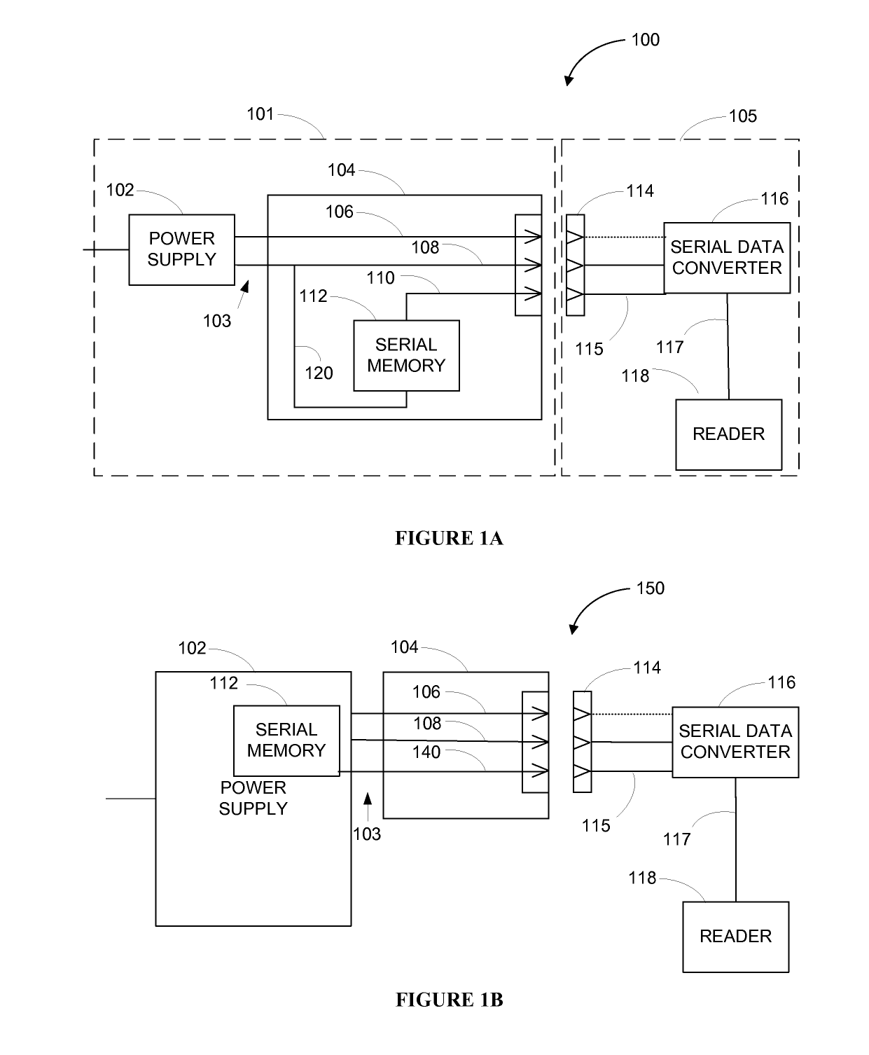

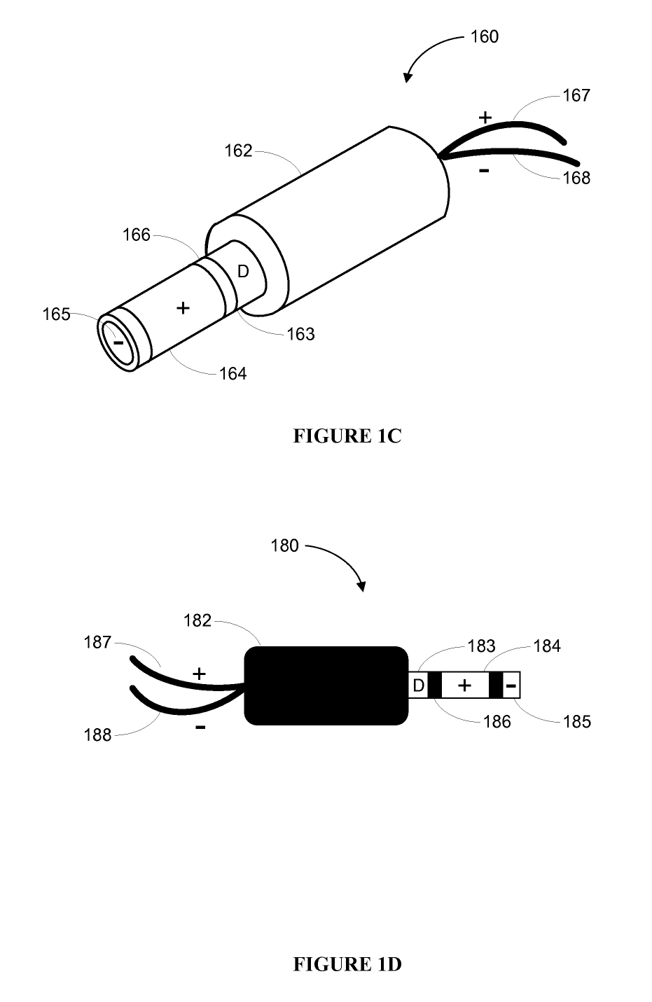

FIG. 1 is a block diagram illustrating a contact-based identification system to associate devices according to various embodiments. Identification system 100 comprises power supply assembly 101 and reader assembly 105. Power supply assembly 101 comprises power supply 102 that is coupled to output connector 104 via electrical cable 103. Reader assembly 105 comprises serial data converter 116, e.g., a serial-to-USB converter, coupled between receptacle 114 and reader 118.

Power supply 102 may be any power source, including an AC/DC adapter. Serial memory 112 is coupled within output connector 104 to output a serial data signal via serial data line 110. In one embodiment, power supply 102 is configured to provide to output connector 104, via electrical cable 103, a positive power signal through first conductor 106 and a negative power signal through second conductor 108. First and second conductors 106, 108 provide the positive and negative power signals in the form of a current and/or a voltage.

In detail, electrical cable 103 comprises at least two conductors 106, 108 to conduct power from power supply 102 to one or more contact surfaces of output connector 104. First and second conductors 106, 108 and serial data line 110 are composed of any suitable electrically conductive material, such as copper. Each of conductors 106, 108 and serial data line 110 is connected to at least one contact surface of output connector 104. For example, second conductor 108 may be used to carry current of a negative polarity from power supply 102 to outer connector of output connector 104, while first conductor 106 carries current of a positive polarity from power supply 102 to an inner connector of output connector 104.

Serial memory 112 may be a non-volatile memory that is located within output connector 104 and is coupled between a ground connection, such as conductor 108, and a data connection, such as serial data line 110, which is coupled to a conducting surface of output connector 104. Note that no powered connection is required to read data from serial memory 112.

In one embodiment, power is diverted from power supply 102 to energize an integrated circuit (not shown), which contains serial memory 112. For example, first conductor 106 may provide current or voltage to serial memory 112. Memory 112 may be a 1 kB memory chip that is embedded within an integrated circuit. The integrated circuit is molded into the housing of output connector 104, e.g. at one end of a barrel connector. One lead of the memory chip may be soldered to conductor 108 and a second lead is soldered to a conducting surface of output connector 104, so that the output of output connector 104, conductors 106, 108, and serial data line 110 are available to couple to receptacle 114 of reader assembly 105. Any molding technique known in the art may be used to ensure that the product comprising the embedded chip is not visually different than if no chip were embedded.

Memory 112 serves to hold identification data, such as manufacturing date, lot number, serial number etc., and identify a counterpart device (not shown) that is designed to receive output connector 104. For example, the identification data may be used to identify the AC/DC adapter holding the serial memory and to associate an electric drill that the adapter is configured to mate to, including data such as the operating voltage of the electric drill and the amount of power that the drill is designed to draw from the adapter.

In one embodiment, the identification data is permanently stored into serial memory 112. For example, the identification data may be programmed by the chip manufacturer, at time of manufacture, using a single write operation. The stored identification data may be subsequently read out from memory 112 through serial data signal 110 by a read-only process. In an alternative embodiment, the identification data may be rewritten multiple times into serial memory 112 embedded in an integrated circuit that is capable of processing data with a microcontroller. For example, a chip manufacturer may supply an unprogrammed chip to the power supply assembly manufacturer, who then programs the identification data, as needed. In yet another embodiment, memory 112 may contain identification data in both a read-only memory and a rewritable memory for use in multiple applications.

Serial memory 112 may additionally include various levels of data protection, including encryption and password protection, that provide secure communication to reader 118. For example, a chip manufacturer may store a password within memory 112 that a host, such as reader 118, would have to supply prior to being granted access to request or modify any data stored on memory 112. Numerous ways of providing a communication channel between the memory and reader are possible. Physical connections include serial I/O protocols, such as RS-232, SPI, or I2C. In one embodiment, a 1-Wire® data communication over a single signal is used, wherein line 120 shares the same ground as output connector 104 in which serial memory 112 is embedded. Other embodiments are possible but would require additional wiring between output connector 104 and receptacle 114, which would increase cost and complexity.

In one embodiment, output connector 104 provides data from serial memory 112 to reader 118 via serial data converter 116. Output connector 104 is a DC power connector, comprising three electrical contacts, similar to an automotive cigarette lighter plug having a nominal polarity of 12 V. In one embodiment, output connector 104 has a cylindrical shape with two or more electrically conducting contact surfaces. Typically, at least two of the contact surfaces are concentric, one on the outer side of a barrel-style body and one on the inner side. Two or more of the contact surfaces may be aligned in a co-linear fashion to provide multiple independent power or signal lines. Between the two or more contact surfaces is disposed electrically insulating material. Outer contact of output connector 104 is connected to one polarity of power supply 102, e.g. a negative polarity, while the inner contact is connected to an opposite polarity of power supply 102, e.g. a positive polarity. Further, disposed at the center of the barrel connector may be a center pin. Each of the contact surfaces may be configured to receive and transmit power and data signals.

FIG. 1C illustrates an implementation of an output connector for use in an identification system to associate devices according to various embodiments. Output connector 160 comprises two outer contact surfaces 163, 164 and one inner contact surface 165. Outer contact surfaces 163, 164 are aligned in a co-linear fashion and separated by electrically insulating material 166, such as Teflon® or any other suitable dielectric. Unlike in prior art barrel-style connectors commonly found in AC/DC adapters, a total of three contact surfaces are provided. Outer contact surface 164 is coupled to the positive polarity of a power supply (not shown) via first electrical conductor 167, while the inner contact surface 165 is coupled to a negative polarity of the power supply via second electrical conductor 168. Outer contact surface 163 is configured to receive and transmit serial data signals via a serial data line, as previously mentioned. One skilled in the art will appreciate that any permutation of the polarities of the conducting surfaces may be chosen. Similarly, the inner contact may be split instead of the outer contact to achieve similar functions.

FIG. 1D illustrates an alternative implementation of an output connector for use in identification system to associate devices according to various embodiments. Output connector 180 comprises three outer contact surfaces 183, 184, 185 separated by two sections of electrically insulating material 186. Contact surfaces 184, 185 are coupled to the positive and negative polarity of the power supply via first electrical conductor 187 and second electrical conductor 188, respectively, while contact surface 183 is configured to receive and transmit serial data signals via the serial data line.

Returning now to FIG. 1A, output connector 104 is configured to be inserted into a counterpart receptacle 114. The mating receptacle comprises two or more contacts configured to receive output connector 104 and to make electrical and mechanical contact with the contact surfaces of output connector 104. Output connector 104 is composed of any suitable electrically conductive material, such as nickel-plated copper. One skilled in the art will recognize that different shapes and materials may be substituted to provide power and data from power supply 102 to reader 118 and to insulate conducting surfaces from each other.

Receptacle 114 is configured to receive output connector 104 to establish a communication channel for data transmission between memory 112 and reader 118 via serial data converter 116. In one embodiment, matching receptacle 114 receives serial data signal 110, which comprises identifying data, and transmits it to serial data converter 116. Serial data converter 116 converts serial data signal 110 into second data signal 117, which comprises the identifying data in a different format.

With regard to a coaxial output connector 104, receptacle 114 may be a socket mounted directly to the housing of reader 118. Alternatively, receptacle 114 may be extended by electrical cable 115. In yet another alternative, a serial-to-USB adapter cable having a multi-pin connector may be utilized to directly connect receptacle 114 to a USB input port of reader 118. Receptacle 114 need not connect to or utilize each contact of output connector 104. In one embodiment, receptacle 114 comprises at least one contact for serial data signal 110. A designated contact, such as a center contact, may be used to transmit data signals between memory 112 and reader 118.

In one embodiment, receptacle 114 may be designed as one or more power connectors, such as a set of modified DC barrel connectors that provide numerous input connectors of varying sizes and shapes to form a universal reader from which a user may select a matching connector.

Reader 118 may be implemented as a plug and play USB reader that is internal or external to a computer or any other portable electronic device that is capable of displaying information. In one embodiment, serial data converter 116 converts serial data from serial memory 112 to USB formatted data, which is second data signal 117. Reader 118 receives second data signal 117 via a USB enabled interface and displays the data on a human-readable display, such as an LCD.

Data transmission based on a USB protocol well understood in the art, and a detailed description is omitted herein. The USB interface advantageously supplies by cable the power necessary to operate serial memory 112, thus the data contained in serial memory 112 can be obtained without power supply assembly 101 being plugged into a wall outlet. One additional benefit of the USB interface is that USB is a universally accepted de facto standard for low power applications, and is built in into many devices, including portable devices, such as cellular phones.

As shown in FIG. 1B, serial memory 112 may be embedded within power supply 102. In identification system 150, electrical cable 103 comprises at least three conductors, e.g., copper wires. First and second conductors 106, 108 are configured to carry power and third conductor 140 carries data signals from power supply 102 to one or more contact points of output connector 104. The conductors are connected to corresponding contact surfaces on output connector 104. For example, first conductor 106 may be configured to carry current of a positive polarity from the power supply to the inner connector of output connector 104, while second conductor 108 may be configured to carry current of a negative polarity from power supply 102 to the outer connector of output connector 104, and third conductor 140 carries a data signal from memory 112 to the center connector of output connector 104. The data signal carries identification data regarding the content stored in serial memory 112, such as identification data discussed previously.

One skilled in the art will recognize that the data signal may carry any sort of information, including data related and unrelated to hardware or software described herein. For example, the data signal may carry information containing a counter to count the total hours of operation or the power consumed by a piece of equipment, such as a counterpart device that output connector 104 is designed to mate to.

In one embodiment, power supply 102 is utilized to transmit power to reader 118 via output connector 104. In another embodiment, matching receptacle 114 receives power from reader 118 to provide power to serial memory 112 via second and third conductors 108, 140, respectively. In this embodiment, power and data signals are multiplexed on third conductor 140.

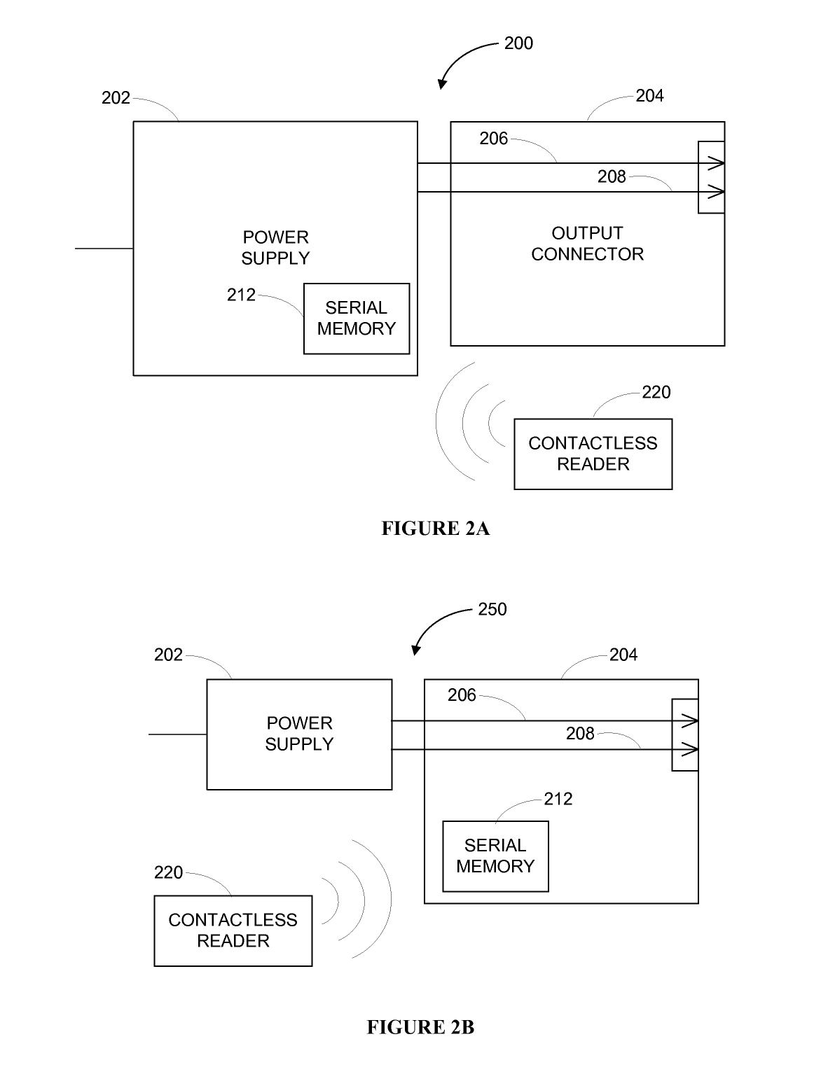

FIG. 2A is a block diagram illustrating a contactless identification system to associate devices according to various embodiments. Serial memory 212 may be implemented as a non-volatile memory that is embedded in an identifier tag, e.g., a radio frequency identification (RFID) transponder or a smart card to allow communication with a reading device. The identifier tag may be a simple, low-cost device such as for use with a near field communication (NFC) contactless transponder reader. With reference to contactless embodiments, serial memory 212 is embedded within an integrated circuit that can be molded into the housing of power supply 202. Serial memory 212 comprises identification data that can be read out with contactless reader 220. As such, serial memory 212 acts as an electronic identifying label to identify the electrical characteristics of power supply 202 and that of one or more products that power supply 202 is associated with. As illustrated in FIG. 2B, serial memory 212 may embedded within an integrated circuit molded into output connector 204, e.g. into a barrel power supply connector.

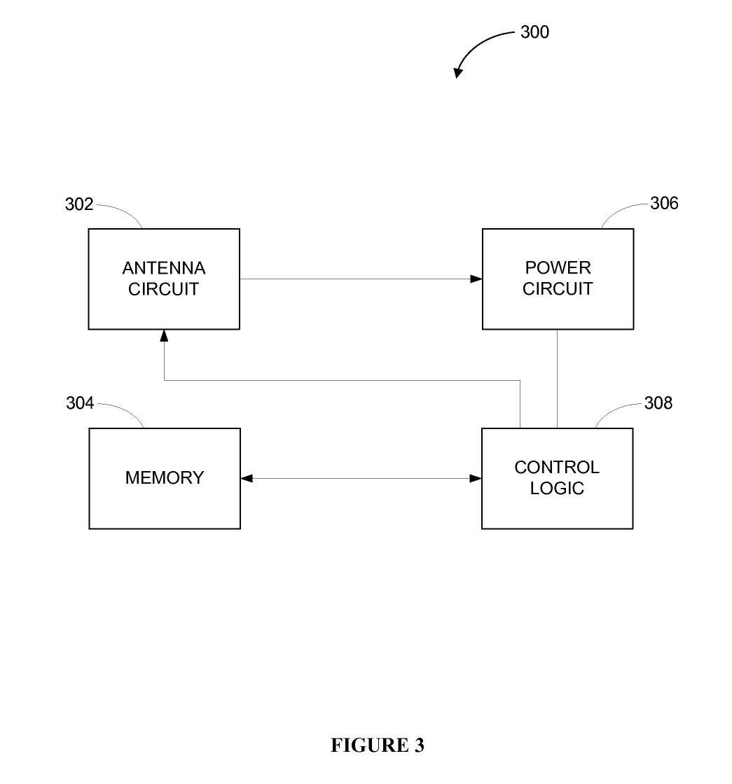

FIG. 3 is a block diagram illustrating an identifier tag according to various embodiments. Identifier tag 300 is configured to communicate with a reading device, such as a transponder reader. Identifier tag 300 comprises a communications circuit that is based on RFID technology.

In one embodiment, identifier tag 300 comprises passive circuitry that is configured to communicate with contactless reader via radio frequency (RF) technology. Such circuitry may comprise a resonant structure that draws energy from an electromagnetic field. The source of energy is the RF field that is generated by a tag reader (not shown) at a designated frequency, such as 13.56 MHz. Part of the energy that identifier tag 300 draws is used to operate antenna circuit 302, memory 304, power circuit 306, and control logic 308. The energy may be extracted, for example, over a number of consecutive cycles.

Power circuit 306 comprises power storage capabilities that allow it to store some or all of the extracted energy. Once tag 300 is energized, it can actively communicate to the contactless reader. The powering of tag 300 and the communication with the contactless reader may occur simultaneously. In one embodiment, tag 300 is an active transponder with its own source of energy, e.g. a battery, and tuning circuitry that allow identifier tag 300 to transmit data to the contactless reader. The data comprises identifying information for a piece of hardware that is associated with the product that carries tag 300.

Antenna circuit 302 comprises one or more antennae that may operate at various resonant frequencies where each antenna is designed to efficiently transfer energy at its resonant frequency. Antenna circuit 302 enables wireless communication between tag 300 and the contactless reader in accordance with a chosen RF communication standard.

The antenna signals transmitted by antenna circuit 302 can be regulated in amplitude, phase, or both. One skilled in the art will appreciate that other examples and combinations of modulation may be employed to achieve effective identification data transmission without departing from the scope of the present invention.

Control logic 308 serves to control the signals transmitted by antenna circuit 302 and to communicate with memory 304. Control logic 308 comprises controls to read out identification data from memory 304 and to convert the data into corresponding RF signals for transfer by antenna circuit 302. Control logic 308 may comprise additional circuitry to process and provide data protection for secure communication between tag 300 and the contactless reader. The identification data may be permanently stored into memory 304, for example, by the tag manufacturer, and may associate the tagged item with its associated product. In one embodiment, both a read-only memory and a rewritable memory are provided.

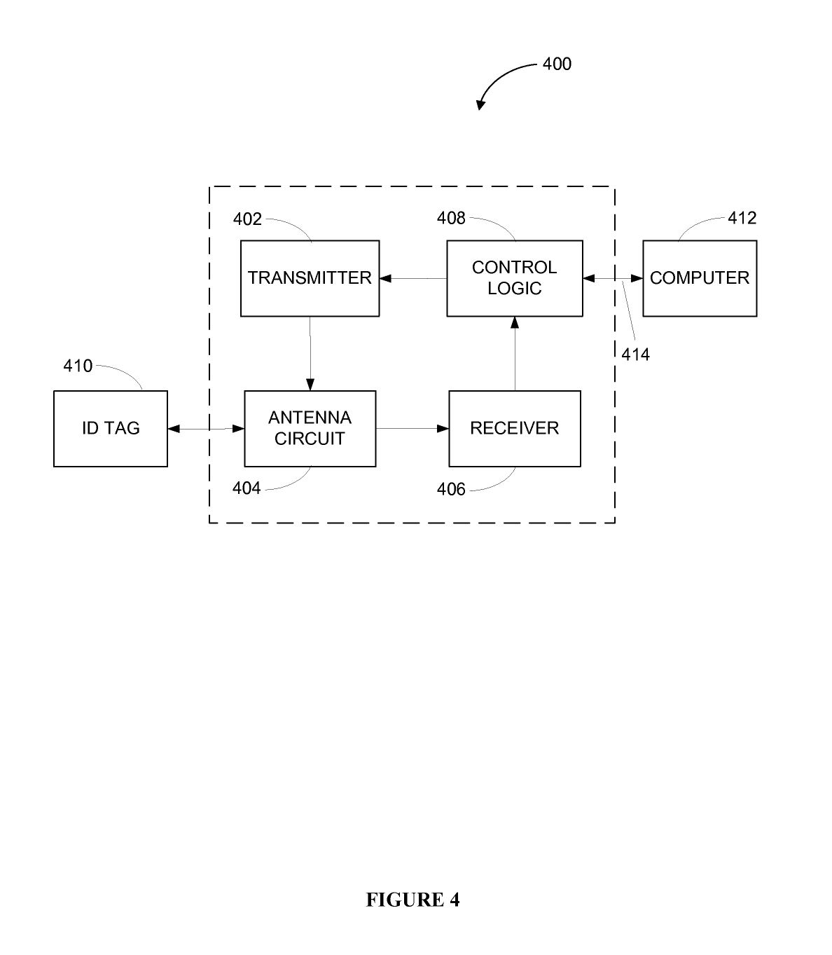

FIG. 4 is a block diagram illustrating a contactless ID reader according to various embodiments. Reader 400 comprises transmitter 402, antenna circuit 404, receiver 406, and control logic 408. Reader 400 may be an RFID reader with a USB controlled interface.

In one embodiment, reader 400 is configured to enable data exchange between ID tag 410, which stores identifying data about an associated item on ID tag 410, and computer 412, which can display the identifying data on a display. Reader 400 reads out data stored on ID tag 410 via a communication channel established between ID tag 410 and reader 400 according to a communications protocol. Communication is established over one of various types of wireless data transmission protocols, including infrared, RF, microwave, Bluetooth, Wifi, Wireless USB and other protocols. In addition, other techniques, including optical techniques, such as lasers, may be used.

Reader 400 enables a data exchange between ID tag 410 and computer 412. Computer 412 may be equipped with an application program for executing data exchange with reader 400 via a communication cable 414. Alternatively, data may be transmitted in accordance with a data transmission protocol between a serial memory located within ID tag 410 and reader 400, where reader 400 is an NFC-enabled portable device having a relatively short reading range, such as a cellular phone. Data stored on the non-volatile memory of ID tag 410 may be user accessible to allow for re-writing of data via transmitter 402 and antenna circuit 404. Thus, a user may identify a product associated with a particular item, for example an AC/DC power adapter, by scanning the adapter carrying ID tag 410 with an NFC-enabled cellular phone.

Antenna circuit 404 is configured to transmit and receive RF signals to and from ID tag 410. Receiver 406, receives from antenna circuit 404 the RF signals that carry among other information the identifying data. Control logic 408 serves to control and decode the received signals and to communicate with computer 412. The control circuit enables mutual data exchange between receiver 406 and computer 412, for example, via corresponding USB interfaces (not shown) on reader 400 and computer 412. The USB interface of reader 400 and the USB interface of computer 412 may be interconnected via a communication cable comprising a USB plug. Control logic 408 is coupled to a serial-to-USB data converter circuit to perform the serial-to-USB conversion. An adapter may be used to convert the output of reader 400 to a suitable signal for the read-out device. In one embodiment, computer 412 may perform serial-to-USB conversion over a serial port, for example, by using an appropriate driver application program that is made available on a website.

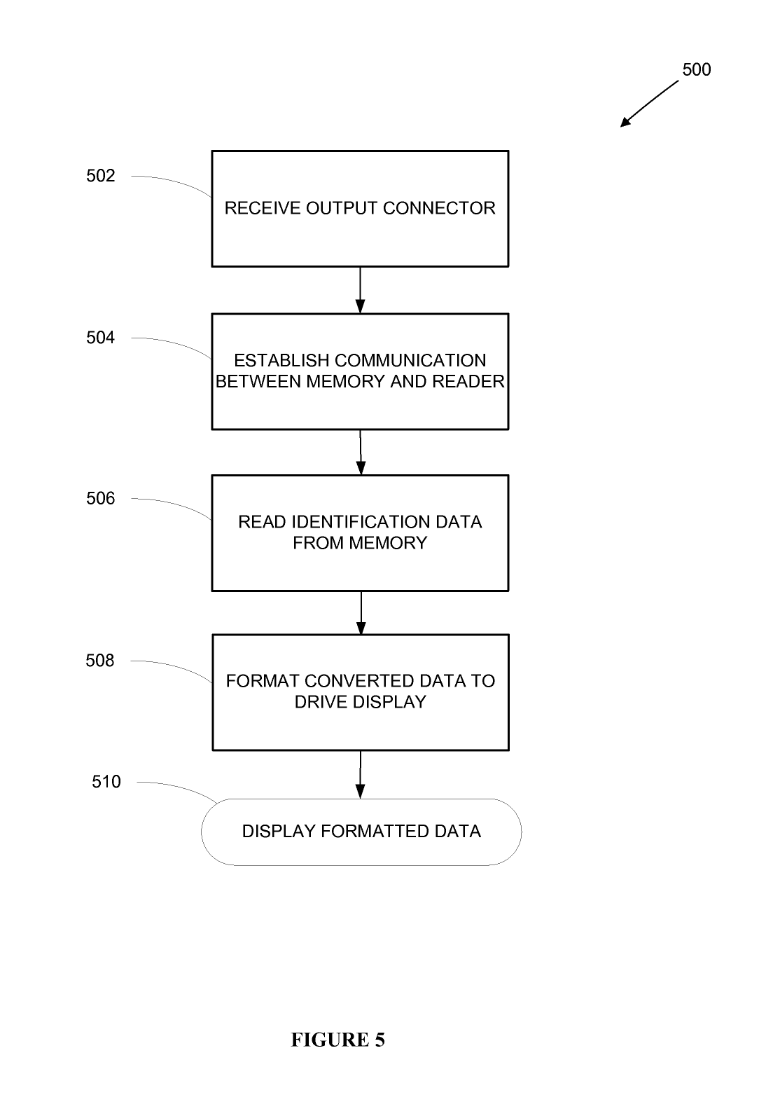

FIG. 5 is a flowchart of an illustrative contact-based process for identifying associate devices in accordance with various embodiments of the invention.

At step 502, a receptacle receives an output connector that is coupled to a serial memory.

At step 504, communication is established between the memory and a reader that is coupled to the receptacle.

At step 506, the reader reads the identification data from the memory.

At step 508, the identification data is converted into a format that can be displayed on a display.

At step 510, the formatted identification data is viewed on a display device, such as a computer monitor or handheld device.

It will be appreciated by those skilled in the art that fewer or additional steps may be incorporated with the steps illustrated herein without departing from the scope of the invention. For example, the identification data may be converted from serial data into a USB format via a serial-to-USB converter prior to being converted into data that can be displayed on a display. Furthermore, no particular order is implied by the arrangement of blocks within the flowcharts or the description herein.

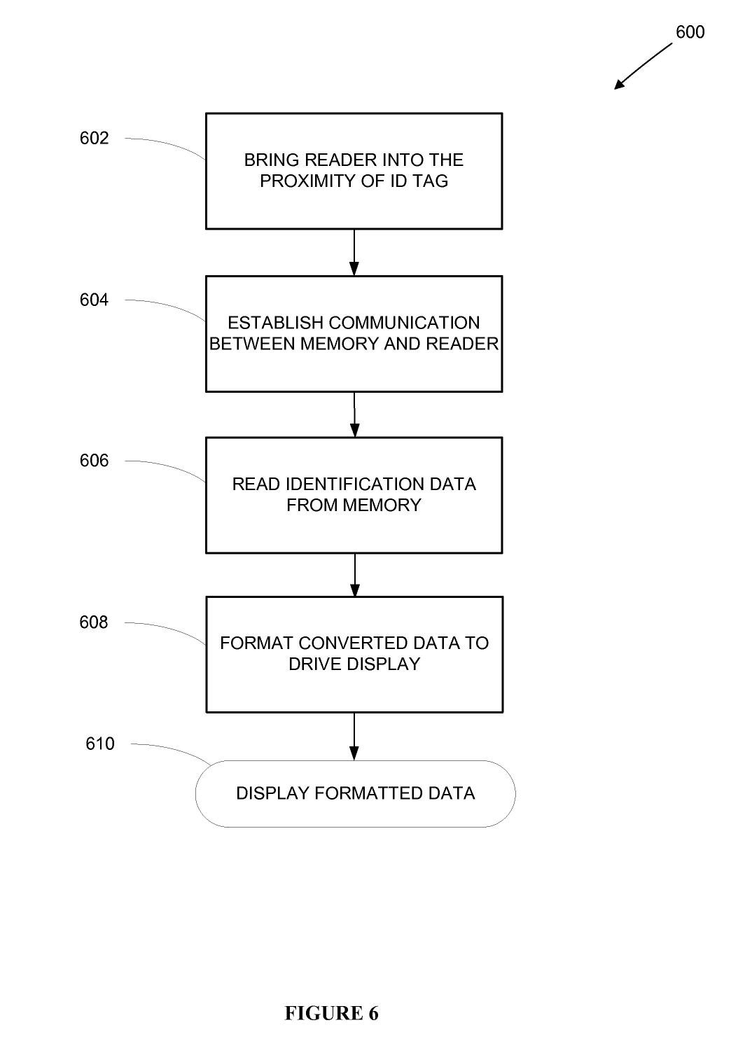

FIG. 6 is a flowchart of an illustrative contactless process for identifying associate devices in accordance with various embodiments of the invention.

At step 602, a reader is brought into the proximity of an identifier tag that comprises a serial memory.

At step 604, communication is established between the memory and the reader.

At step 606, the reader reads the identification data from the memory.

At step 608, the identification data is converted into a format that can be displayed on a display.

Finally, at step 610, the formatted identification data is viewed on a display device, such as a computer monitor or handheld device, such as an NFC-enabled phone.

It will be appreciated that the preceding examples and embodiments are exemplary and are for the purposes of clarity and understanding and not limiting to the scope of the present invention. It is intended that all permutations, enhancements, equivalents, combinations, and improvements thereto that are apparent to those skilled in the art, upon a reading of the specification and a study of the drawings, are included within the scope of the present invention. It is therefore intended that the claims include all such modifications, permutations, and equivalents as fall within the true spirit and scope of the present invention.

We claim:

1. An identification apparatus to associate devices, the identification apparatus comprising:
a first device comprising first and second power lines, the first and second power lines couple to an output connector that is configured to couple to a second device;
a serial data line coupled to output connector, the serial data line serves to exchange data with the second device; and
a memory coupled to the output connector via the serial data line, the memory stores identification data that associates the first device with the second device.

2. The identification apparatus according to claim 1, wherein the memory is coupled between the second power line and the serial data line.

3. The identification apparatus according to claim 1, wherein the identification data is permanently stored into serial memory.

4. The identification apparatus according to claim 1, wherein the serial data multiplexes power and data onto a single contact on the output connector.

5. The identification apparatus according to claim 1, wherein the output connector comprises:
a body defined by insulating material enclosed between a first and a second concentric surface along the center axis of the body;
a first contact disposed on an inner edge of the first concentric surface and a second contact disposed on an outer edge of the second concentric surface, the first and second contact receive and transmit power signals; and
a third contact positioned at the center axis of the body, the third contact receives and transmits a data signal.

6. The identification apparatus according to claim 1, wherein the output connector comprises:
a body defined by insulating material enclosed between a first and a second concentric surface along the center axis of the body;
a first contact disposed on an inner edge of the first concentric surface;
a second contact disposed on an outer edge of the second concentric surface, the first and second contact receive and transmit power signals; and
a third contact disposed on the outer edge of the second concentric surface aligned co-linear with the second contact, the third contact receives and transmits a data signal.

7. The identification apparatus according to claim 1, wherein the output connector comprises:
a body defined by insulating material enclosed between a first and a second concentric surface along the center axis of the body;
a first contact disposed on an inner edge of the first concentric surface;
a second contact disposed on an outer edge of the second concentric surface, the first and second contact receive and transmit power signals; and
a third contact disposed on the inner edge of the first concentric surface aligned co-linear with the first contact, the third contact receives and transmits a data signal.

8. An identification apparatus to associate devices, the identification apparatus comprising:
a power supply comprising an output connector, the power supply is configured to provide power signals of a first and second polarity to energize a counterpart device;
a memory coupled to receive the power signal of the second polarity, the memory stores identification data that associates the power supply with the counterpart device; and
a serial data line coupled between the power signal of the second polarity and the output connector, the serial data line enables data exchange between the memory and a reader.

9. An identification system to associate devices, the system comprising:
a power supply configured to couple to a counterpart device, the power supply is configured to provide power signals of a first and a second polarity;
an output connector coupled to the power supply, the output connector receives a serial data signal;
a memory coupled to an output of the output connector, the memory stores identifying data that identifies the counterpart device;
at least one receptacle configured to couple to the output connector, the at least one receptacle receives the power signal of the second polarity and the serial data signal, wherein the serial data signal comprises the identifying data;
a converter coupled to receive the serial data signal from the receptacle; and
a reader coupled to the converter to receive the serial data signal.

10. The system according to claim 9, wherein the output connector further receives the power signals of the first and second polarity.

11. The system according to claim 9, wherein the memory is further coupled to the power signal of the first polarity.

12. An identification system to associate devices, the system comprising:
a power supply assembly comprising:
a power supply coupled to a first power line and a second power line, the power supply assembly is configured to couple to a counterpart device;
an output connector coupled to the power supply; and
a memory coupled between the second power line and a serial data line, the first and second power lines and the serial data line are further coupled to an output of the output connector, the memory stores identifying data that identifies the counterpart device;
at least one receptacle configured to couple the serial data line;
a converter configured to receive the identifying data from the memory via the serial data signal that comprises the identifying data; and
a reader coupled to receive the serial data signal.

13. The system according to claim 12, wherein the receptacle receives power from the power supply to power the receptacle.

14. An identification system to associate devices, the system comprising:
a power supply configured to couple to a counterpart device;
a memory disposed on an integrated circuit chip, the memory is configured to store identifying data that identifies one or more properties of the counterpart device; and
a contactless reading device configured to receive the identifying data via wireless communication.

15. The system according to claim 14, wherein the wireless communication is in accordance with a radio frequency communication standard.

16. The system according to claim 14, wherein the integrated circuit comprises a passive circuit to communicate with the contactless reading device, the passive circuit comprises a resonant structure that draws energy from an electromagnetic field generated by the contactless reading device.

17. The system according to claim 14, wherein the integrated circuit is an active transponder comprising a power storage device.

18. The system according to claim 14, wherein the memory is embedded within an output connector of the power supply.

19. The system according to claim 14, wherein the contactless reading device is a NFC transponder reader.

20. A method of associating devices, the method comprising:
receiving an output connector of a power supply assembly that comprises a memory with a receptacle that is coupled to a reader assembly;
establishing a communication between the memory and the reader assembly;
reading identification data that is stored on the memory;
converting the identification data to a displayable format; and
displaying the formatted data on a display unit.

21. The method according to claim 20, wherein establishing a communication further comprises adding a data protection that provides secure communication determining that a connection has been made.

22. The method according to claim 20, wherein establishing a communication further comprises adding a data protection that provides secure communication between the memory and the reader assembly.
